(19) United States
(12) Patent Application Publication
(10) Pub. No.: US 2010/0161727 A1
(43) Pub. Date: Jun. 24, 2010

(54) System and Method for Accelerating a Wide Area Notification

(75) Inventors: Shmuel Shaffer, Palo Alto, CA (US); Zeeshan R. Khan, Fremont, CA (US)

Correspondence Address: Patent Capital Group - Cisco, 6119 McCommas, Dallas, TX, 75214, US

(73) Assignee: Cisco Technology, Inc.

(21) Appl. No.: 12/340,468

(22) Filed: Dec. 19, 2008

(51) Int. Cl. G06F 15/16

(52) U.S. Cl. 709/204

(57) ABSTRACT

A method is provided that includes evaluating a message to be communicated to one or more persons and evaluating social network data that is indicative of a social network of the persons. The social network of the persons is used as a basis for communicating the message to one or more persons in the social network. In other embodiments, a selected one of the persons in the social network responds to receiving the message by sending the message to other persons in another social network to which the selected person belongs. In still other embodiments, the social network can be restricted to persons associated with a geographical area and the geographical area can be associated with a location from which the message originates. In yet other embodiments, communicating the message comprises making a telephone call or communicating the message comprises out-of-band signaling.

### TECHNICAL FIELD OF THE INVENTION

The present invention relates generally to communications and, more particularly, to a system and a method for accelerating wide area notification.

### BACKGROUND OF THE INVENTION

Alerting people through an automated message service finds use in many situations. In particular, these services can be helpful for alerting people about a dangerous condition. Typically, an emergency center makes or coordinates phone calls to alert individuals in a population of an emergency such as a fast spreading fire, a storm (hurricane, tornado, etc.), the presence of dangerous wildlife, etc.

Messaging centers can have one or more telephone ports connected to a computer dialing system. The computer dialing system, in an emergency, opens a database of people to be contacted. This process can be lethargic, time intensive, and expensive.

### BRIEF DESCRIPTION OF THE DRAWINGS

In order to provide a better understanding, example embodiments will now be described in greater detail, by way of example only, with reference to the accompanying figures, in which:

FIG. 1 is a simplified diagram of an example of a network of persons where each person being represented by a letter in accordance with an example of the present invention;

FIG. 2 is a flowchart of an example embodiment of the present invention method;

FIGS. 3-5 are simplified diagrams of additional examples of networks of persons in accordance with an example of the present invention;

FIGS. 6-10 are flowcharts of other potential example embodiments of the present invention method; and

FIGS. 11-12 are simplified block diagrams illustrating example components that may be included in certain embodiments of the present invention.

### DETAILED DESCRIPTION OF EXAMPLE EMBODIMENTS

### Overview

According to an example embodiment of the present invention, a method is provided that includes evaluating a message to be communicated to one or more persons and evaluating social network data that is indicative of a social network of the persons. The social network of the persons is used as a basis for communicating the message to one or more persons in the social network. In other embodiments, a selected one of the persons in the social network responds to receiving the message by sending the message to other persons in another social network to which the selected person belongs. In still other embodiments, the social network can be restricted to persons associated with a geographical area and the geographical area can be associated with a location from which the message originates. In yet other embodiments, communicating the message comprises making a telephone call or communicating the message comprises out-of-band signaling.

One embodiment of the invention uses social networks to accelerate the process of mass notification. In this embodiment, the social network can be a group of individuals such as friends, relatives, workmates or other groups of people that may interact and communicate between themselves. Alternatively, the individuals may be brought together by common values, visions, ideas or interests. A social network can be represented as a tree or web-like structure whose connections can be facilitated by network communications (e.g., over an IP network, over a cellular network, over e-mail, over out-of-band signaling [texting], etc.). Individuals in the network may be represented as “nodes.” Connections between the nodes represent a potential for communication between the connected persons. Structures comprising interconnected nodes may be stored in computer memory as an appropriate data structure for evaluation. Examples of representations of social networks are those stored and managed by social networking web sites such as MySpace, Facebook, LinkedIn, or other groups, which do not necessarily include an associated web site. For example, the social network could be a group developed organically by one or more persons seeking to establish or develop some group relationship.

Some embodiments of the invention use the representations of social networks stored by databases or by web sites. Once a person in a social network has a message sent to them by a message center (or management element), that person can propagates the message to persons they are connected to within the network. These people, in turn, pass the message to their contacts [e.g., found in a repository, database, or queue], or alternatively the message can be passed on to a predetermined list of people (either configured by a user of the end-user device, or by a service provider, or by an administrator). Any such information is referred to as ‘social network data’ as used herein in this Specification. This social network data can be the aforementioned information or alternatively include any number of data segments, attributes, or identification tags that can assist in communicating the received message to one or more persons that share a social network with the person that received the message.

The message may include instructions to propagate the message, or this may be understood by the recipient by way of prior arrangement, for example. In some embodiments, the message is of a nature that would encourage its recipient to pass the message on with or without instruction. Consequently, the message may be propagated to more people and more rapidly than can be achieved with the limited number of ports available on typical mass notification systems.

The message may be propagated to a plurality of people using established social networks. This may include sending the message to a subset of persons within the network which will on forward the message to other persons within the network via their network connections. The subset of persons is determined by merit. For example, if a better (e.g. more efficient) propagation of a message is achieved by sending it initially to a particular person, then that person is favored.

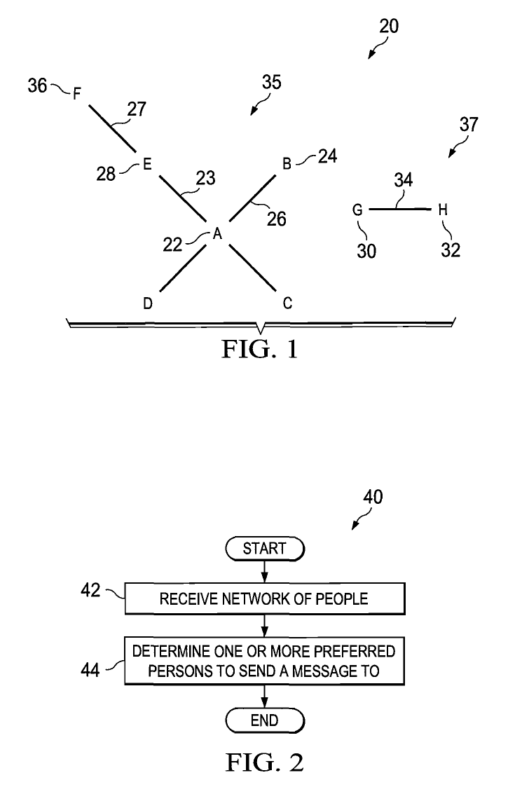

FIG. 1 shows an example of a social network of persons generally indicated by reference numeral 20, each person being represented by a letter. For example, the letter A 22 represents a person connected to person B 24 via a connection 26. The network 20 comprises sub-networks 35 and 37. It is assumed that each person will on receipt of the message propagate it to everyone they are connected to within the network. For example, if the person A 22 received a message then A 22 would in turn propagate the message to the persons labeled B, C, D and E. Persons G 30 and H 32 are also part of the network 20; however, they are only connected to each other via connection 34 and not to any of A 22 through F 36. Thus, if person A 22 received a message, the message would be passed on to B 24 through F 36 but not by G 30 and H 32. A second message should be sent to either G 30 or H 32 in order for the message to be received by everyone in the network of persons 20.

A social network may be simple or basic. For example, a network may comprise two interconnected people. It may comprise one person connected to a plurality of other people, who are otherwise not connected. Alternatively, it could be much larger, or scale to larger magnitudes.

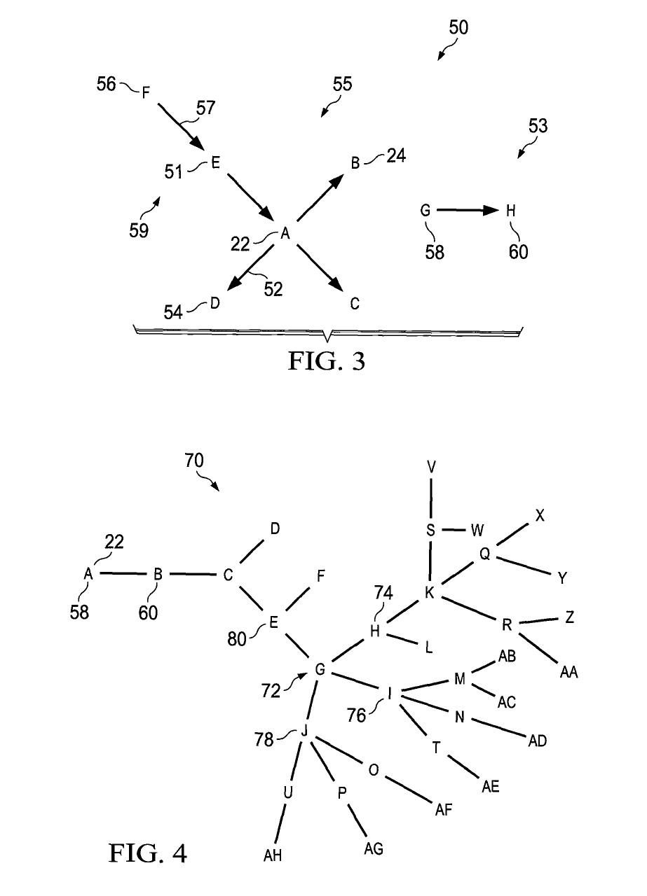

FIG. 2 shows one embodiment of a method generally indicated by reference numeral 40. The method may be used to propagate a message, such as an emergency message, through a network of persons, such as network 20, in an accelerated manner. In this embodiment 40, data indicative of a social network such as 20 is received (step 42). It is then determined which person or persons it is most desirable to send a message to, that is, who are the one or more preferred persons. Considering FIG. 1, it will be understood that in some circumstances person A 22 is a preferred person because they have the maximum number of connections in the network. That is, by the message center sending the message to A, the message will then reach the connected parties B, C, D and E from A without the center having to send any further messages. In this embodiment, the step of determining the preferred person A 22 is achieved by counting the connections each of A through H have. This is generally illustrated by step 44. For the network of persons 20 in FIG. 1, person A has the maximum number of connections. It will also be appreciated that either G 30 or H 32 are also preferred persons as they are not connected to person A 22, either directly or indirectly through another person, and thus will not receive the message if A is informed. Either G 30 or H 32 should be sent a message if members of the sub-network 37 is to be reached.

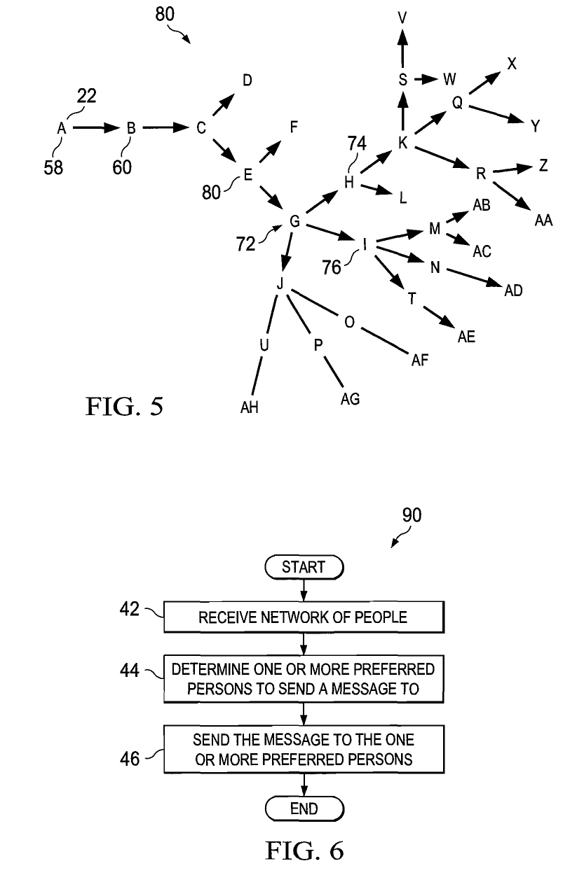

Another example of a network of persons 50 is shown in FIG. 3. In this network, some of the connections such as 52 are directional, that is, it is assumed that the message propagates in only one direction through this connection 52 as indicated by the arrow. If A 22 was given the message then A 22 would contact D 54 and pass the message on. However, if D 54 was given the message it would not be passed on A 22. For this network 50, it will be appreciated that person F 56 is a preferred person as the message propagate from F 56 to everyone within network 50 except for G 58 and H 60. It will further be appreciated that for similar reasons person G 58 is preferred over person H 60. In determining the one or more preferred persons in network 50, a decision may be made in which order preferred persons F 56 or G 58 should be sent the message. In this network 50, it will be appreciated that person F 56 is preferred over person G 58 because person F is connected to a larger sub-network, and thus more people ultimately receive the message from a single telephone call. For the network shown in FIG. 1 indicated by numeral 20, it will be appreciated that person A is the most preferred person and should be sent the message first, because they have the most number of connections and are in the larger of the two sub-networks 35 and 37. The message will propagate fastest through the network if A is contacted first. Either G 30 or person H 32 may be second in the order of person to send the message to because in this case the connection 34 is not directional.

For the network in FIG. 3, it will be appreciated that person F 56 is preferred over person E 51 because everyone in sub-network 55 will be notified if F 56 is given the message but not if E 51 is given the message due to the unidirectional nature of connection 57 between person F and person E. That is, F would not receive the message. The maximum number of people is notified if person F 56 is the most preferred person. Looked at another way, person F 56 is on a branch 59 of the network. People on this branch 59 will only receive the message if the message is sent to a person on this branch 59, preferably F 56 who terminates the branch 59 which ensures everyone on the branch will receive it.

FIG. 4 shows another example of a network of persons 70. In this case, person G 72 is the most preferred person because sending a message to G 72 starts a chain reaction through H 74, I 76, J 78 and E 80. Sending the initial message to person A 22 will also start a chain reaction once the message reaches person G 72, but initially the message should propagate linearly through persons B, C and E first.

FIG. 5 shows another example of a network of persons 80 including both directional and non-directional connections. In circumstances where only a single phone call is made, person A 22 is the most preferred person. However, if more than one call passing on the message is available then it may be preferable to first contact person G 72, to start a chain reaction, and then person A 22 who terminates a branch of the network 80.

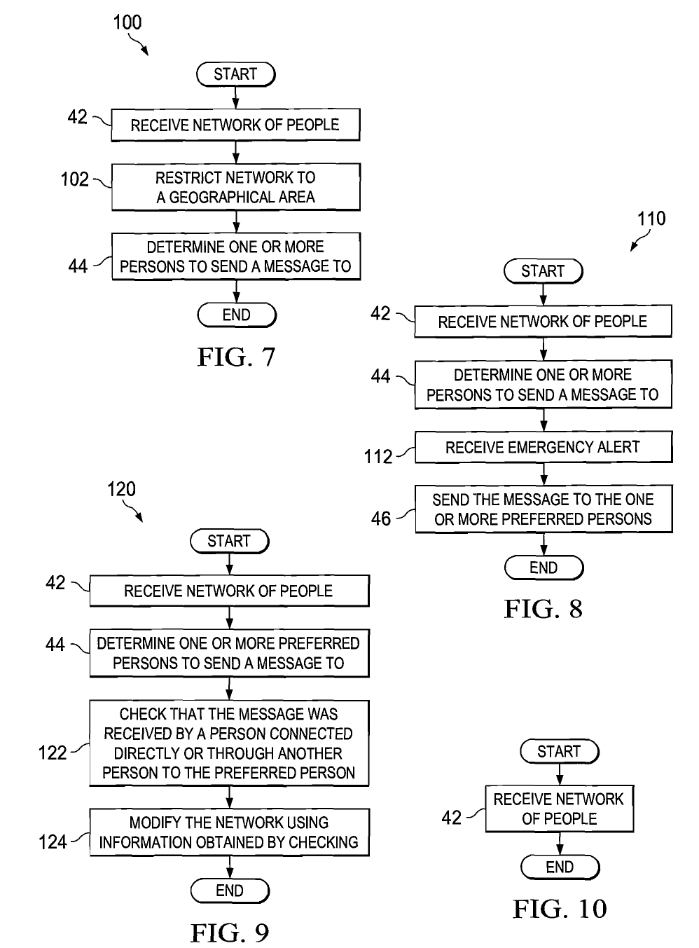

FIG. 6 shows an example operational flow 90 for one implementation of the present invention. In this embodiment, a network of people is received at step 42. After determining the one or more preferred persons to send the message to (step 44), the message is sent to the one or more preferred persons (step 46), possibly in a predetermined order as described above.

In another operational embodiment 100 as shown in FIG. 7, the network of persons is restricted to a geographical area (shown by step 102). For example, the network may be restricted to persons having a particular message center serving their telephone. This may be done to balance the load on the center. Alternatively, in a case where the message asks people to flee an effected area, people closest to the escape route may be notified preferentially in order to better regulate the outgoing traffic.

FIG. 8 shows another operational embodiment 110 of the present invention. In this embodiment, before the step of sending a message to one or more preferred persons (step 46), an emergency alert is received (step 112). The emergency alert may be received via a telephone call from a concerned citizen, for example. Alternatively, the emergency alert may be received by an official body.

FIG. 9 shows another operational embodiment 120, which includes the step of checking that the message was received by a person connected directly (or through another person) to the preferred person who received the original message from the message center (step 122). For example, in relation to FIG. 1, if person A 22 was the preferred person who received the original message, it may be checked that the message propagated through the network to person E 28 or person F 36 by contacting them, for example. If either of these people is found not to have received the message, the network may be modified using information obtained via checking (shown as step 124). If, for example it was found E (FIG. 1) had not received the message, the network may be modified by deleting connection 23 to indicate that A could not be relied on to inform E. The network could be modified after testing of the network by sending a practice or dummy alert, for example. Alternatively, the network could be modified after a real emergency message being sent. In the case of a real emergency, if person F was checked with and found not to have received the message, the method may then include the step of sending a message to E (as well as possibly F); especially in the case that connection 27 flowed from E to F. E or F may be informed that A failed to pass the message on. It will be appreciated that network modification as described above acts as an inducement for people to actively pass on messages and have extensive networks. If they are found not to pass messages on, they may be disconnected and given low priority. In this case, it may take longer for the message to reach them. Thus, greater network connectivity is encouraged resulting in an enhanced and even more accelerated wide area notification.

One way of determining the one or more preferred persons comprises finding a minimal spanning tree of the network, where the network is represented by a graph were each person is a node and the connectedness between each person is the weight on the edge. Initially, the method does not have enough information about all the people (nodes), so it uses a distributed minimum spanning tree protocol similar to that used in Ethernet which is to construct a loop free topology. Algorithms for finding a minimum spanning tree include Boruka's algorithm, Prims algorithm, Kruskal's algorithm, and the Bernard Chazelle algorithm.

In one example network, it is assumed that the network graph includes persons A, B, C, D. User A is registered as willing to notify user B, user B is registered as willing to notify user C, and so on. Each person A through D is given a weight according to the length of the graph for which he is the originator. In our example, A through D are assigned respectively weights of 3, 2, 1 and 0. In case of an emergency, the system can utilize its single port to notify person A in relying on person A to notify B, who in turn would notify C, who would notify user D. As part of the adaptive aspect of the method, the system may call user D after some time to verify that he is being notified. If a system determines the notification chain has failed the system adaptively modifies its internal graph description of the network of persons. As part of this graph modification, the system marks some connections as unreliable and modifies users of the failure of the social network. For example, if person C fails to notify user D, the weights of users A through D are respectively modified to 2, 1, 0 and 0.

Of course, the network of persons should be first received to implement the methods described above. In one embodiment, people register to receive notification alerts. Their social networks are received by the notification system. Registration may be through a web page, for example. Users may be offered the option of manually entering the names of their social network peers, as shown in FIG. 10. The user may be given an option of entering the names of the social peers he is willing to notify, the names of the social peers he can rely to notify him, or both. This last aspect is related to the directionality of the connections described above. Alternatively, a user can provide details of their social network portal such as LinkedIn or Facebook. The person allows the emergency notification system to query the social network application to exchange information with it. The networks of different people may be stitched together for form larger networks.

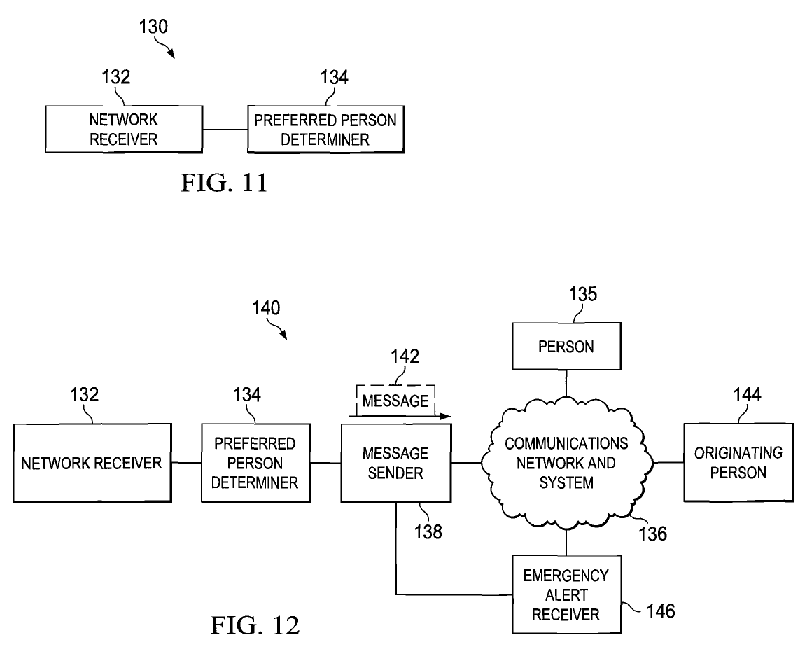

FIG. 11 shows an example system 130 that carries out at least some of the methods described above. System 130 includes a social network data receiver 132 for receiving social network data indicative of the network of persons. The system 130 also includes a preferred person determiner 134 for determining one or more preferred persons to send a message to, on the assumption that each person in the network on receipt the message propagates the message to persons they are connected to within the network. The network receiver 132 and determiner 134 may be one or more computer servers connected to the internet, for example, accessible by a web browser on a computer of person A 22.

In another embodiment, the social network data indicative of a network of persons is not a complete set of social network data. For example, the data may only have the names of the people who have the most or nearly the most number of connections. A corresponding system need only perform the steps of receiving the social network data indicative of the one or more preferred persons in a network of persons and send a message to the one or more preferred persons.

FIG. 12 shows another embodiment of an example system 140. System 140 also includes a message sender for sending the message, such as the emergency message, to a preferred person such as person 135 via a communications network and system 136 which may be, for example, a Plain Old Telephone Network, a Voice-over-IP or Mobile phone network, or a wide area network in which case the message may be sent as an email and the message sender 138 is an email server. The message may be alternatively a page, SMS or Fax or another element, which may be based on particular communication needs. In this embodiment, the message sender 138 is triggered by an emergency alert receiver 146 to send the message 142. The message alert receiver 146 may be connected to the communications network 136 and may, for example, receive a phone call or email or other alert from an alert originating person 144. The various components of the system 140 may comprise a general or purpose built computer system or systems or embedded systems. These typically include logic encoded in tangible media such as a hard drive, random access memory, flash memory, EPROM, EEPROM, CD Rom or DVD, for example. The logic instructs the components of the system 140 to perform embodiments of the methods.

The focus is now turned to a number of examples for illustrating some of the features of certain embodiments of the present invention. In one example, a person accesses a web site enabling them to register for an emergency message service. The person is prompted to enter their contact details such as emergency contact numbers, email and pager details. The person is then prompted to enter other individuals that they are willing to contact if they receive an emergency message and pass the message on to. In this example, the person enters the details of their immediate family, and workmates. In this example, the person is instructed through the web site that they are to pass any emergency messages they receive from the system onto the people they have nominated. After registration, the person may then encourage his/her contacts to register with the service and enter their own contacts. This process expands and increases the value of the social network data held by a corresponding system of the web site.

In another example, a person rings a call center to register for the service. The person informs the person at the call center who is handling their request, that they are registered with a social networking web site such as Facebook. The person gives permission for their social network data stored on that web site to be used by the emergency message center. The emergency center extracts social network data from the social networking site and stores it. Messages are sent to members of the person's social network informing them that the person has registered with the emergency message service and letting them know how they can also register with the service. The more people that register with the service the larger and better the social network stored in the emergency message service system is.

In yet another example, a person logs into a web site of an emergency message service. The emergency message service web site has a social networking aspect, such as Facebook or MySpace. The person is able to enter all their contacts and then have the message service system invite their contacts to also join the emergency message service. All the people who register with the service receive a message, in this case through a web page, which tells them that they should pass on the message they receive to the people they have nominated as contacts.

Now that embodiments have been described, it will be appreciated that some embodiments have some of the following advantages. For instance, the original message from the center will propagate through the preferred person's network without requiring the center to contact each of these people in the network separately. In addition, a given message can propagate in a chain reaction or exponentially growing process which results in a message being received by more people in a shorter time period. Also, by checking if people connected to the preferred person have received the message, the progress of the message through the network can be at least estimated and faults in the message propagation corrected. Note also that the network can be modified if it is found that on an occasion a message that should have been propagated did not pass beyond a particular person. Moreover, because of the chain reaction or exponential nature of the process a very large number of people can be rapidly altered using a small system. It should also be noted that the possibility of the network being modified on failure of a message being propagated acts as an inducement for people to actively pass on messages and to extend their network.

Although in some of the described embodiments the messages comprise emergency, “evacuate” or other messages, the message type is not limited to these examples. For example, the message may be an advertisement, public announcement or political message, for example. The message could be any type of message, sent over any system such as phone, email, pager, etc.

As can be appreciated by the foregoing description and the discussions herein, the coordination of the responses for these alert messages can occur at the edge of the network, at a server, as part of one or more end-user devices, or performed as a hybrid of these functions. Thus, an alert event can be captured and subsequent responses properly coordinated by a management element, a server, a router, etc. and all of these items can have the intelligence to dictate an effective response mechanism, as prescribed herein.

Software (which manages the operations of the system in accordance with some embodiments of the invention) can reside in the network. By “reside in the network” such terminology is meant connote that the software can be hosted on any suitable device or component in a communications infrastructure. These elements may include any suitable combination of software or hardware to execute the response mechanisms and/or perform the coordination of distributing messages as outlined herein. All of these potential elements may be referred to as ‘management elements’ as used herein in this Specification, which could be routers, switches, gateways, bridges, loadbalancers, firewalls, servers, end-user devices, or any other suitable device, component, element, or object operable to assist in these activities. Moreover, these management elements may include any suitable hardware, software, components, modules, interfaces, or objects that facilitate the operations thereof. This may be inclusive of appropriate algorithms and communication protocols that allow for the effective exchange of data or information in the architecture.

Each of these management elements can also include memory elements for storing information to be used in achieving the message management and coordination operations, as outlined herein. Additionally, each of these devices may include a processor that can execute software or an algorithm to perform the messaging activities, as discussed in this specification. Memory elements and processors (which facilitate these outlined operations) may be included in these management elements or provided externally to these elements, or consolidated in any suitable fashion. The processors can readily execute code (software) for effectuating the activities described. These devices may further keep information in any suitable random access memory (RAM), read only memory (ROM), erasable programmable ROM (EPROM), electronically erasable PROM (EEPROM), application specific integrated circuit (ASIC), software, hardware, or in any other suitable component, device, element, or object where appropriate and based on particular needs.

The management elements could be part of any the elements included in the FIGURES (e.g., the network configurations of FIGS. 1, 3-5, or provided in any of the components of FIGS. 11-12). Alternatively, this management element could be its own separate proprietary element (e.g., a server) responsible for the activities outlined herein. The management element can coordinate, organize, or otherwise manage any number of activities in terms of forwarding, receiving, communicating, etc. messages propagating in the network.

Note also that the specific coordination and response mechanisms may be provided external to any of the management elements, as opposed to provided internally. In addition, some, all, or none of these operations may be suitably combined across these elements, or provided in just one element to accomplish the operations as outlined herein in this document. In some cases, there could be reciprocal software (for example, in the end-user devices) that identifies the incoming message and then sends that message (either a copy or a modified message) to persons in their social network.

Note that with the examples provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that the communication system (and its teachings) are readily scalable and can accommodate a large number of components, as well as more complicated/sophisticated arrangements and configurations. Accordingly, the examples provided should not limit the scope or inhibit the broad teachings of the communication system, as potentially applied to a myriad of other architectures.

It is also important to note that the steps in the preceding flows illustrate only some of the possible scenarios that may be executed by, or within, the communication system. Some of these steps may be deleted or removed where appropriate, or these steps may be modified or changed considerably without departing from the scope of the present invention. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the tendered communication systems in that any suitable arrangements, chronologies, configurations, and timing mechanisms may be provided without departing from the teachings of the present invention.

Note that the end-user devices described herein are providing just some of the many examples that could be used in conjunction with the present invention. These devices (referred to as ‘end-user devices’ as used herein in this document) may include cellular telephone, I-phones, VHF radios, UHF radios, PSTN telephones, IP phones, push-to-talk telephones, laptops, desktop computers, personal digital assistants (PDAs), or any other suitable end-user device capable of exchanging data in the architecture.

Although the present invention has been described in detail with reference to particular arrangements and configurations, these example configurations and arrangements may be changed significantly without departing from the scope of the present invention. For example, although the present invention has been described with reference to particular communication exchanges involving emergency alerts (e.g., natural disasters, bombings, rescue efforts, fires, auto accidents, flooding, contaminations issues [e.g., in the air, water system, etc.], etc.) the communication system can also manage other notifications and events on other pathways. Note also that the term ‘message’ as used herein in this Specification is meant to connote any type of message, signal, data exchange, or notification that was intended for one or more end users. The message may inform the end users or apprise them of some situation, or alternatively simply convey some information from a sender. This may include, not only alerts that may suggest more urgent matters, but simple conversational exchanges and/or simple correspondence between two end users operating their end-user devices.

Additionally, although described with reference to possible emergency, police, and fire fighter type applications, the present invention can certainly be used in operational environments where there are simple communication flows propagating amongst users within a given group. These communication environments could involve non-emergency scenarios.

Numerous other changes, substitutions, variations, alterations, and modifications may be ascertained to one skilled in the art and it is intended that the present invention encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this invention in any way that is not otherwise reflected in the appended claims.

What is claimed is:

1. A method, comprising:
evaluating a message to be communicated to one or more persons; and
evaluating social network data that is indicative of a social network of the persons, wherein the social network of the persons is used as a basis for communicating the message to one or more persons in the social network, and wherein the message relates to an emergency alert.

2. The method of claim 1, wherein a selected one of the persons in the social network responds to receiving the message by sending the message to other persons in another social network to which the selected person belongs.

3. The method of claim 1, wherein the social network is restricted to persons associated with a geographical area.

4. The method of claim 3, wherein the geographical area is associated with a location from which the message originates.

5. The method of claim 1, further comprising:
communicating the message to one or more preferred persons of the social network.

6. The method of claim 1, wherein communicating the message comprises making a telephone call.

7. The method of claim 1, wherein communicating the message comprises out-of-band signaling.

8. The method of claim 1, further comprising:
verifying that the message has been received by a person in the social network.

9. The method of claim 1, further comprising:
determining a minimal spanning tree of a network to identify the persons in the social network.

10. An apparatus, comprising:
a management element that evaluates a message to be communicated to one or more persons and evaluates social network data that is indicative of a social network of the persons, wherein the social network of the persons is used as a basis for communicating the message to one or more persons in the social network, and wherein the message relates to an emergency alert.

11. The apparatus of claim 10, wherein a selected one of the persons in the social network responds to receiving the message by sending the message to other persons in another social network to which the selected person belongs.

12. The apparatus of claim 10, wherein the social network is restricted to persons associated with a geographical area, and wherein the geographical area is associated with a location from which the message originates.

13. The apparatus of claim 10, wherein communicating the message comprises making a telephone call or comprises out-of-band signaling.

14. The apparatus of claim 10, wherein the management element verifies that the message has been received by a person in the social network.

15. Logic encoded in one or more tangible media for execution and when executed by a processor operable to:
evaluate a message to be communicated to one or more persons; and
evaluate social network data that is indicative of a social network of the persons, wherein the social network of the persons is used as a basis for communicating the message to one or more persons in the social network, and wherein the message relates to an emergency alert.

16. The logic of claim 15, wherein a selected one of the persons in the social network responds to receiving the message by sending the message to other persons in another social network to which the selected person belongs.

17. The logic of claim 15, wherein the social network is restricted to persons associated with a geographical area, and wherein the geographical area is associated with a location from which the message originates.

18. The logic of claim 15, wherein the code is further operable to:
verify that the message has been received by a person in the social network.

19. A system, comprising:
means for evaluating a message to be communicated to one or more persons; and
means for evaluating social network data that is indicative of a social network of the persons, wherein the social network of the persons is used as a basis for communicating the message to one or more persons in the social network, and wherein the message relates to an emergency alert.

20. The system of claim 19, wherein the social network is restricted to persons associated with a geographical area, and wherein the geographical area is associated with a location from which the message originates.

21. The system of claim 19, further comprising:
means for verifying that the message has been received by a person in the social network.

22. The system of claim 19, further comprising:
means for determining a minimal spanning tree of a network to identify the persons in the social network.
